(19) United States
(12) Patent Application Publication
(10) Pub. No.: US 2011/0248005 A1
(43) Pub. Date: Oct. 13, 2011

(54) Laser Cutting Method and Equipment, with means for Modifying the Laser Beam Quality Factor by a Diffractive Optical Component

(75) Inventors: Francis Briand, Paris (FR); Gaia Ballerini, Paris (FR); Isabelle Debecker, Paris (FR); Hakim Maazaoui, Pierrelaye (FR); Erie Verna, Boissy L'Aillerie (FR)

(73) Assignee: L'Air Liquide Societe Anonyme Pour L'Etude Et L'Exploitation Des Procedes Georges Claude, Paris (FR)

(21) Appl. No.: 13/063,689

(22) PCT Filed: Aug. 26, 2009
(86) PCT No.: PCT/FR09/51629

§ 371 Date: Jun. 6, 2011

(30) Foreign Application Priority Data
Sep. 12, 2008 (FR) 0856140

(51) Int. Cl. B23K 26/00

(52) U.S. Cl. 219/121.72; 219/121.67

(57) ABSTRACT

A method of cutting a work-piece to be cut by a laser beam, in which an incident laser beam is generated that has an initial beam parameter product (BPP), given by means of a laser source, preferably an ytterbium-doped or erbium-doped fiber laser source, coupled to at least one optical fiber for conveying the beam. Said incident laser beam is brought to a focusing head comprising at least one optical focusing device. The incident laser beam is focused by means of said optical focusing device, so as to obtain a focused laser beam, and the work-piece is cut by means of the focused laser beam. According to the invention, the quality factor of the incident laser beam is adjusted or modified by means of an optical device designed to be able to modify or vary the BPP of a laser beam so as to obtain a modified focused laser beam having a modified BPP which is different from the BPP of said incident laser beam. Associated equipment for implementing said method.

The invention relates to a laser cutting process, the efficiency of which is improved by using an optical device for modifying the quality of the laser beam, in particular a laser beam emanating from an ytterbium-doped fiber laser device.

CO₂ lasers are widely employed in industry for cutting metallic and nonmetallic materials.

Solid-state lasers, such as ytterbium-doped fiber lasers or disk lasers, have also benefitted from major advances in recent years and combine power levels of a number of kW with excellent beam quality unlike bulk solid-state lasers, i.e. Nd:YAG lasers.

Over and above the characteristics that make fiber lasers very suitable laser sources for the industrial cutting of metallic materials, in this case a shorter wavelength than that of CO₂ lasers, which is better absorbed by the metal and able to be transported by an optical fiber, a smaller size and greater reliability, it is expected that their high brightness will significantly improve the cutting performance.

It is generally accepted that focusing a high-power laser beam onto the workpiece to be cut with a small beam diameter and a low angle of divergence may lead to a gain in speed and in cutting quality, namely straight cut faces with no burrs.

In addition, by maximizing the Rayleigh length of the beam, the process is made more tolerant in terms of positioning the focal point in the thickness of the material.

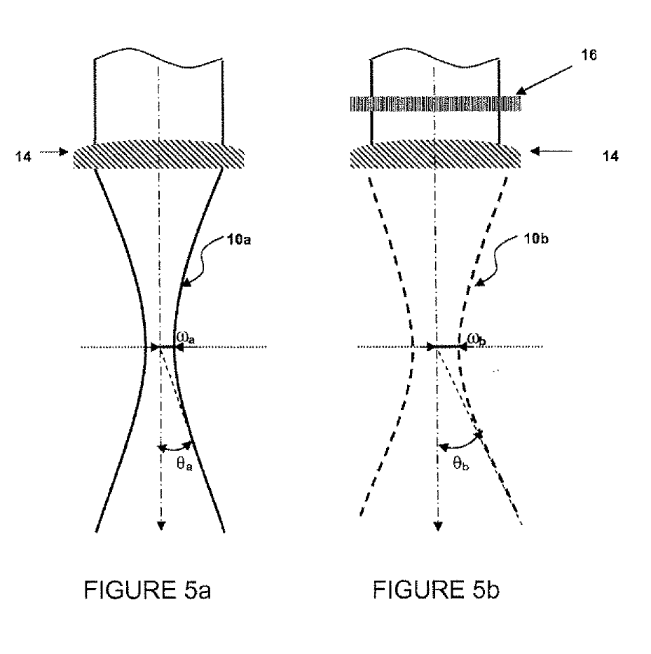

These conditions are satisfied when the cutting process employs laser sources having good beam quality or BPP (Beam Parameter Product). The quality of a laser beam is measured by its BPP, which is expressed as the product of the waist radius ω of the laser beam and its divergence half-angle θ, as illustrated in FIGS. 5a and 5b.

It will be understood therefore why it is often preferable to choose a laser beam of low BPP to guarantee good cutting performance. This is confirmed in particular when cutting metallic materials of small thicknesses, i.e. less than 4 mm, in which a lower BPP generally means an increase in cutting speed, thanks to better efficiency of the process.

However, it is also expected that a higher BPP promotes the removal of the burrs remaining attached at the bottom of the cut faces after passage of the beam, particularly in the case of greater thicknesses, typically 4 mm and higher. Specifically, in cutting trials on mild steel and on stainless steel, better burr elimination has been achieved using a laser beam of higher BPP for 8 to 10 mm thick mild steel plate and 4 mm thick stainless steel plate. It turns out that the impact of a laser beam of larger diameter on the workpiece to be cut makes it possible to open a wider kerf, thereby increasing the penetration and effectiveness of the cutting gas.

Over and above this phenomenon, the fact of changing the BPP of the focused beam makes it possible to modify the spatial distribution of the beam energy over the entire cutting depth. Thus, when a laser beam is used for cutting applications, the possibility of changing its BPP depending on the range of thicknesses to be cut is of great advantage, particularly for demanding applications such as the cutting of small contours, in which the removal of residual burrs is a critical problem.

However, the BPP is a parameter imposed by the characteristics of the optical fiber emitting the laser beam and by the characteristics of the laser source. Thus, this parameter has an influence on the performance, especially the cutting speed and cutting quality, of a cutting process using a fiber laser.

One solution for optimizing the performance of the process would he to work with a batch of optical fibers having different diameters in order to have several BPP values. However, this solution is not conceivable in an industrial environment in which the intensive handling of fibers is not recommended. It also imposes the use of a fiber coupler, which is an expensive element and the performance of which deteriorates over time.

In this context, it is desirable to be able to improve, in a simple manner, the efficiency of a fiber-laser cutting process, especially the cutting speed and/or cutting quality, without having to use several fibers to provide different BPP values, and also to dimension the BPP of the laser beam, especially depending on the thickness of the material to be cut and/or on the composition of said material to be cut, so as to optimize the speed and quality performance of the cutting process.

One solution of this problem is then a process for cutting a workpiece using a laser beam, in which:
a) an incident laser beam, having a given initial beam quality (BPP), is generated by means of a laser source coupled to at least one optical fiber for conveying the beam;
b) said incident laser beam is brought to a focusing head having at least one focusing optic;
c) the incident laser beam is focused by means of the focusing optic so as to obtain a focused laser beam; and
d) the workpiece is cut by means of the focused laser beam also called the cutting laser beam,
   characterized in that the BPP of the incident laser beam is adjusted or modified by means of an optical device suitable for and designed to modify or act on the BPP of said laser beam so as to obtain a modified focused laser beam having a modified BPP that differs from the BPP of said incident laser beam, i.e. in the absence of the BPP modifying optical device, said optical device comprising at least one diffracting optical component and being able to produce a modified focused laser beam, the BPP of which is different from the initial BPP of the incident laser beam by a multiplicative factor equal to or greater than 1.2 but less than or equal to 5.

Depending on the case, the process of the invention may comprise one or more of the following features:
the optical device suitably designed for modifying the BPP of the laser beam is placed in the path of the laser beam, preferably between the beam-conveying fiber and the focusing optic;
the BPP of the incident beam, before its passage into the BPP modifying optical device, is between 0.33 and 25 mm.mrad, preferably less than or equal to 10 mm.mrad, in particular in the case of a conveying optical fiber with a diameter of 200 μm or less;
the BPP modifying optical device is capable of multiplying the BPP of the laser beam by a multiplicative factor equal to or greater than 1.5 and/or less than or equal to 3;
the BPP modifying optical device is at least one transmissive or reflective diffracting optical element;
the focusing head comprises at least one focusing optic and the optical device is suitable for and designed to modify the BPP of the incident laser beam, preferably the focusing head further includes at least one beam collimation optic;
the transmissive optical device is made of fused silica, quartz, of special glass, zinc sulfide (ZnS) or zinc selenide (ZnSe), and preferably it includes an antireflection coating;
the optical device has a thickness of between 0.5 and 10 mm, preferably between 3 and 7 mm, and is advantageously circular with a diameter preferably between 25 and 75 mm;
the optical device is of reflective type, operating with an angle of incidence (α) of between 5 and 50°, and is made of fused silica, quartz, in special glass, zinc sulfide (ZnS), zinc selenide (ZnSe) or metallic material, and preferably includes a reflective coating;
the optical device is designed to modify the BPP and the intensity distribution of the initial beam, preferably of the Gaussian or pseudo-Gaussian type, to another intensity distribution, for example of the ring type, i.e. a hollow-ring or doughnut distribution;
the optical device combines a diffractive function with another function, in particular a laser beam focusing function;
the wavelength of the laser beam is between 1.06 and 1.10 μm;
the power of the laser beam is between 0.1 and 25 kW; and
a laser beam is generated by means of a ytterbium-doped or erbium-doped fiber laser source, preferably an ytterbium-doped fiber.

The invention also relates to a laser cutting unit comprising a laser source, in particular a laser source comprising at least one ytterbium-doped or erbium-doped fiber, preferably an ytterbium-doped fiber, coupled to a beam-conveying fiber in order to generate an incident laser beam of given initial BPP propagating to a focusing head that includes a focusing optic, characterized in that at least one optical device suitable for and designed to modify or adjust the BPP of the focused laser beam is placed in the path of the beam, preferably between the beam-conveying fiber and the focusing optic said optical device comprising at least one diffracting optical component and being suitable for and designed to produce a modified focused laser beam, the BPP of which is different from the initial BPP of the incident laser beam by a multiplicative factor equal to or greater than 1.2 but less than or equal to 5.

The invention will now be better understood from the following description, given with reference to the appended figures in which:

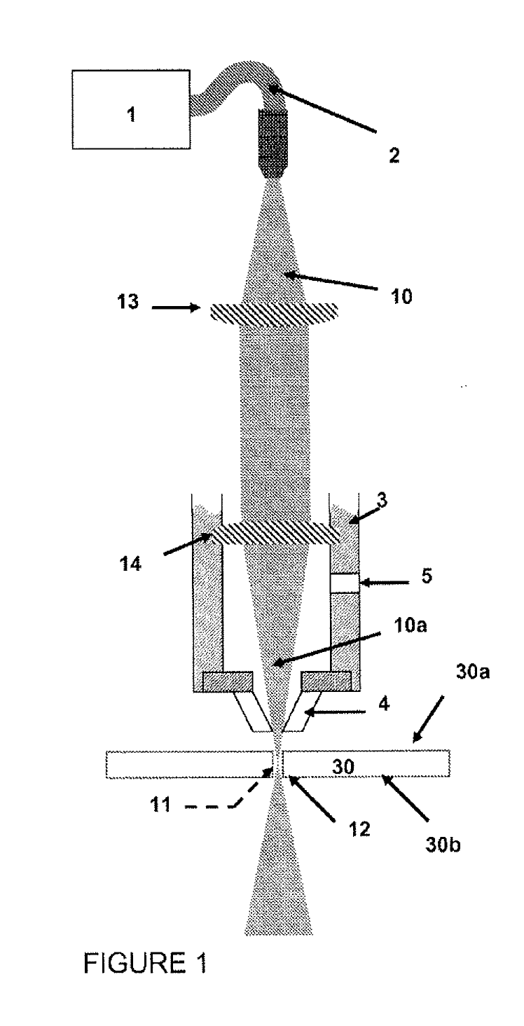

FIG. 1 shows an example of a laser cutting unit without implementation of the invention;

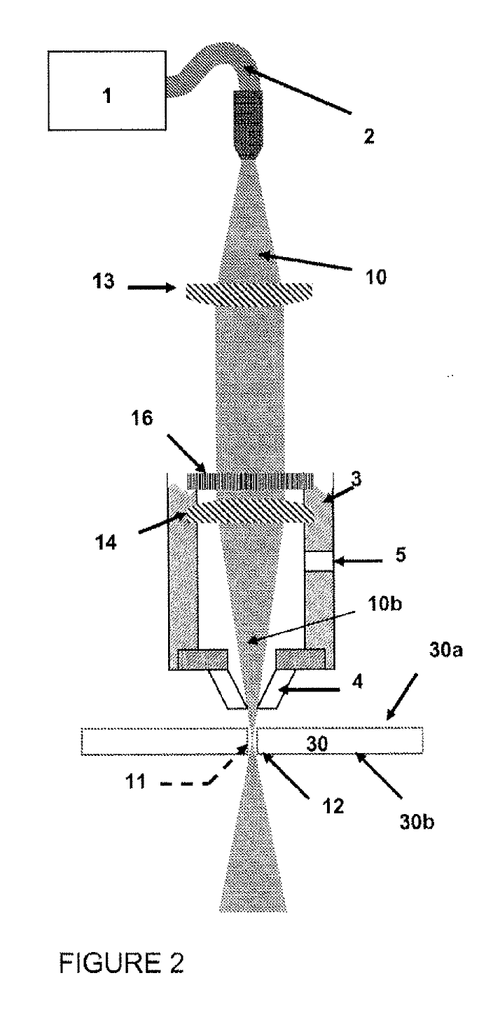

FIGS. 2 to 4 show examples of the implementation of the invention;

FIGS. 5a and 5b illustrate the focused laser beam with its main parameters, namely the waist radius and the divergence of the laser beam, in the absence and in the presence of a diffracting optical element according to the invention in the path of the laser beam, and show schematically an example of what effect such an element may have on the parameters of the focused laser beam;

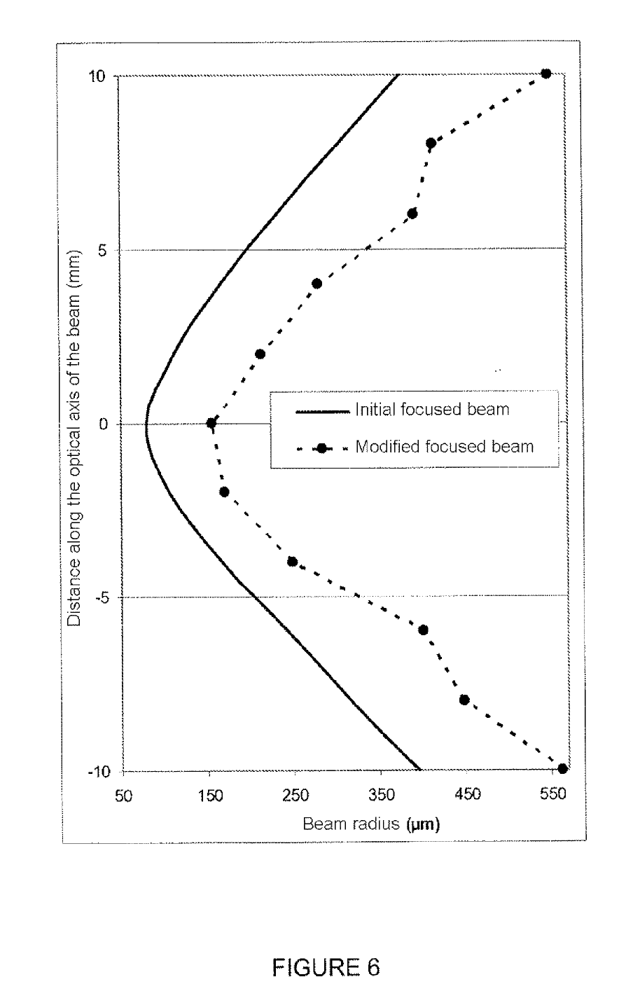

FIG. 6 shows an experimental measurement of the variation in the radius of the focused laser beam along the propagation axis, before and after insertion of a diffracting optical element according to the invention;

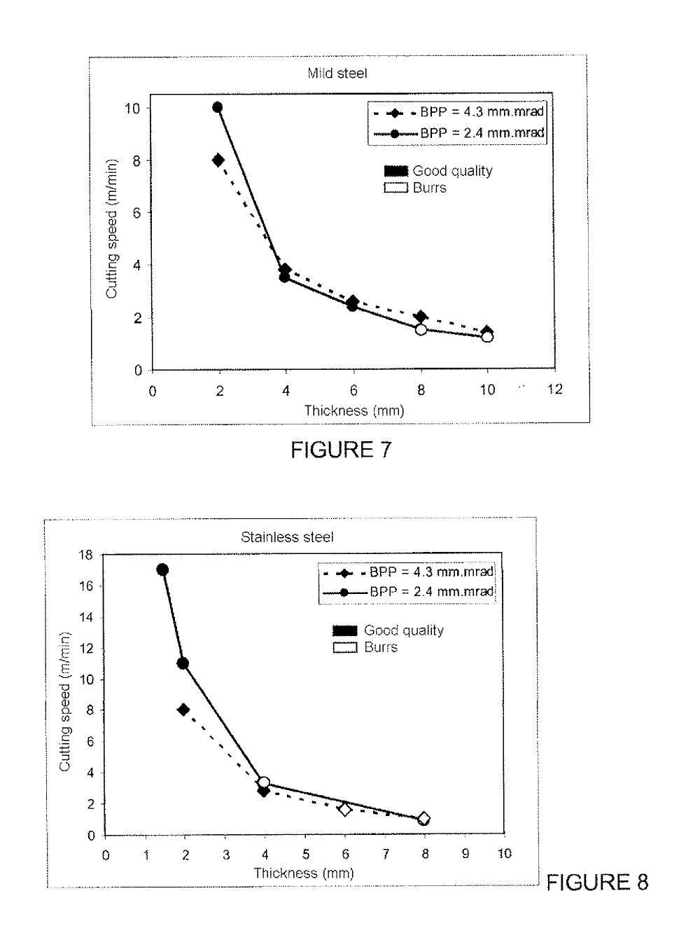

FIGS. 7 and 8 show results of cutting trials carried out on mild steel and on stainless steel, enabling the performances obtained with focused laser beams having two different BPP values to be compared; and

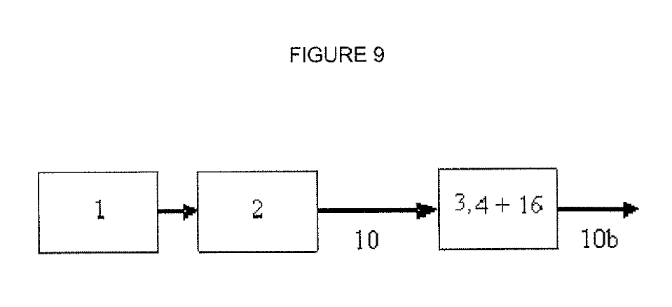

FIG. 9 is a block diagram of one embodiment of a unit according to the invention.

As illustrated in FIGS. 1 to 4 and 9, to cut with a laser beam 10, it is customary to use a laser cutting unit comprising a laser source 1, also called a laser generator or laser device, coupled to a conveying fiber 2 in order to generate an incident laser beam 10 propagating to a focusing head 3 comprising a laser nozzle 4 located facing a workpiece 30 to be cut.

Advantageously, the laser source 1 is a source consisting of ytterbium-doped fibers, that is to say comprising several optical fibers containing or doped with ytterbium (Yb), which serve to generate the laser radiation. Such Yb fiber laser sources are widely available commercially.

Alternatively, the laser source 1 may also be an erbium-doped fiber source.

The focusing head 3 is supplied with an assistance gas via a gas inlet 5 provided in the wall of said focusing head 3 and via which inlet 5 a pressurized gas or gas mixture coming from a gas source, for example one or more gas bottles, a storage tank or one or more gas lines, such as a gas distribution network, is introduced upstream of the nozzle 4 and is discharged via this nozzle 4 toward the workpiece 30 to be cut by the laser beam.

The assistance gas serves to expel the molten metal from the kerf 12 obtained by melting the metal by means of the laser beam 10 which is focused at the position 11 relative to the surface of the workpiece 30 to be cut.

The choice of gas is made according to the characteristics of the material to be cut, especially its composition, its grade and its thickness.

For example, air, oxygen, nitrogen/oxygen mixtures or helium/nitrogen mixtures may be used for cutting steel, whereas nitrogen, nitrogen/hydrogen mixtures or argon/nitrogen mixtures may be used to cut aluminum or stainless steel.

In fact, the workpiece 30 to be laser-cut may be formed from various metallic materials, such as steel, stainless steel, mild steel or light alloys such as aluminum and alloys thereof, even titanium and alloys thereof, and may have a thickness typically between 0.1 mm and 30 mm.

During the cutting process, the beam 10 may be focused (at 11) in or dose to the workpiece 30, i.e. on the outside, that is to say a few mm above or beneath the upper surface 30a or lower surface 30h of the workpiece 30; on the inside, the is to say in the thickness of the workpiece; or else on the upper face 30a or lower face 30b of the workpiece 30 to be cut. Preferably, the position 11 of the focal spot lies between 5 mm above the upper surface 30a and 5 mm beneath the lower surface 30b of the workpiece 30.

The laser beam 10 used in the cutting process of the invention is preferably generated by a solid-state laser, preferably a fiber laser, the wavelength of which is preferably between 1.06 and 1.10 μm. The power of the laser beam 10 is typically between 0.1 and 25 kW, preferably between 1 and 8 kW.

The laser generator 1 may operate in continuous, quasi-continuous or pulse mode. The lasing effect, that is to say the phenomenon of light amplification used to generate the laser radiation, is obtained by means of an amplifying medium, preferably pumped by laser diodes and consisting of one or, typically, more than one doped optical fibers, preferably ytterbium-doped silica fibers. The laser beam is then emitted and conveyed via one or more optical conveying fibers, preferably made of fused silica, the diameter of which is typically between 50 and 200 μm, the conveying fiber not containing ytterbium.

Depending on the characteristics of laser source 1 and the diameter of the optical beam-conveying fiber 2, the BPP value of the incident beam 10 and the BPP value of the initial focused beam are between 0.33 and 25 mm.mrad, preferably equal to or less than 10 mm.mrad in the case of conveying fibers with a diameter of 200 μm or less.

As may be seen, optical devices 13, 14, 15 are then used to direct and focus the laser beam 10 onto the workpiece 30 to be cut and, in accordance with the invention, one or more optical devices 16 is used to modify or adjust the BPP of the incident laser beam, so as to obtain a modified focused beam 10b (FIGS. 2 to 4 and 9) having a modified BPP different from the initial BPP of the initial focused beam, i.e. the beam 10a having an unmodified BPP, as according to the prior art (FIG. 1).

More precisely, one or more collimating 13, redirecting 15 and focusing 14 optics enable the laser beam 10 to be propagated and delivered by the conveying fiber 2 to the workpiece 30. These optical components or elements may work in transmission or in reflection. Thus, the optical collimating and/or focusing systems may be composed of lenses or else of mirrors, mirrors of the spherical or aspherical type, for example parabolic or elliptical mirrors.

These optical components 13 to 15 may be chosen from the various types of mirrors and lenses that are commercially available. They may be made from materials of the following types: fused silica, quartz, special glasses, ZnS, ZnSe or of metallic materials, for example copper, or any other material that can be used in a focusing head 3 for the laser beam 10.

According to the invention, to improve the efficiency of the cutting process using the laser beam 10 delivered by the fiber laser source 1 and the conveying fiber 2, one or more optical devices or components 16 are placed in the path of the beam 10, preferably in the laser cutting head 3, making it possible to obtain a modified focused laser beam having a BPP different than the given initial BPP of the laser beam 10, without complicating the unit.

More precisely, the optical device 16 forming the subject matter of the invention is designed to modify the BPP of the focused laser beam so that its modified BPP differs from the given initial BPP of the beam emitted by the fiber by a multiplicative factor of between 1.2 and 5, thus increasing the BPP, preferably by at least 1.5.

As illustrated in FIGS. 5a and 5b, the optical device 16 changes the value of the BPP of the initial focused beam by modifying the main parameters of the focused laser beam 10a, namely the waist radius ωₐ and the divergence θₐ. The optical device 16 thus makes it possible to obtain a focused beam 10b, the BPP of which is different from that of the focused beam 10a obtained in the absence of said optical device 16.

The focused beam 10b has an intensity distribution similar to that of the unmodified beam 10a, preferably of the Gaussian or pseudo-Gaussian type, or a different intensity distribution, for example of the ring type, i.e. a hollow-ring or a doughnut distribution.

FIGS. 2 to 4 illustrate various embodiments of the invention, namely a transmissive embodiment and a reflective embodiment.

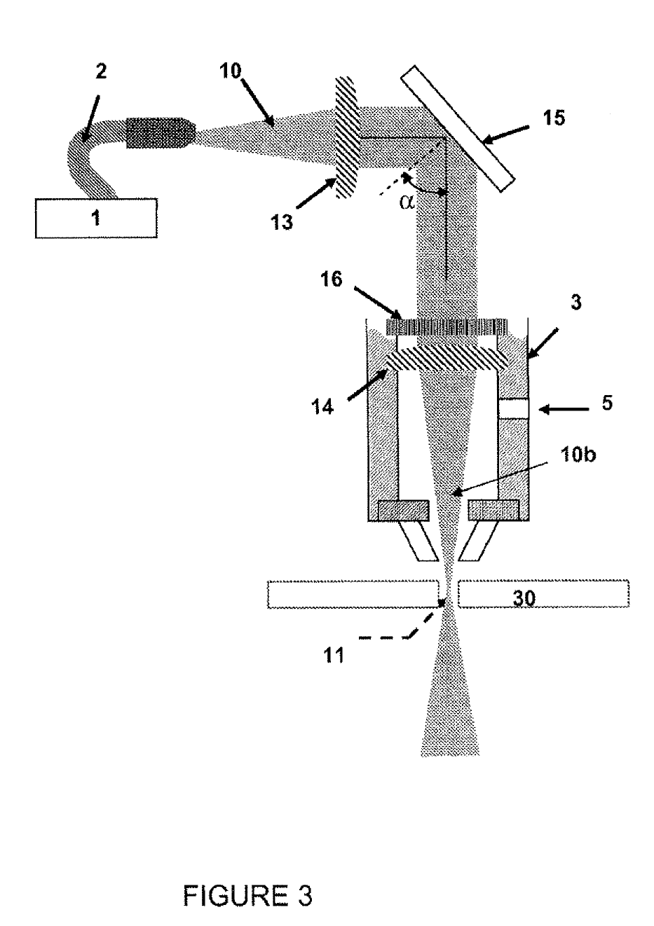

In a first embodiment, the optical device 16 of the invention operates in transmission (FIGS. 2 and 3). In transmissive mode, the materials used for producing the optical device 16 may be fused silica, quartz, special glass, materials of the ZnS or ZnSe type, or any other material transparent at the working wavelength. The two surfaces of the component are preferably treated by depositing an antireflection coating or the like. However, the optical component 16 may also operate without an antireflection coating.

In this case, the optics for collimating, directing and focusing the beam that are integrated into the cutting head 3 operate in transmission (FIGS. 1 and 2) or they include at least one reflective component, operating at an angle of incidence α of between 5 and 50°, for example a plane mirror (FIG. 3) or a mirror of spheric or aspheric shape.

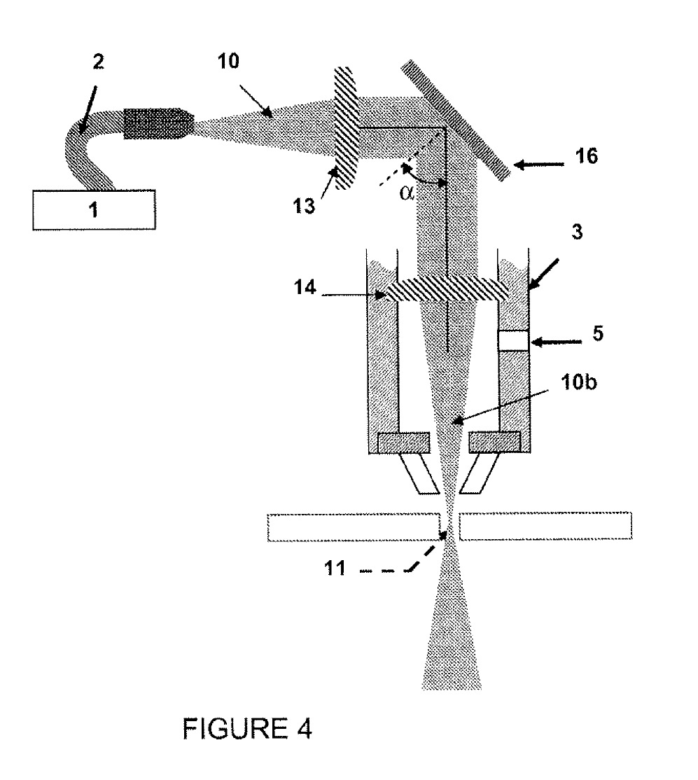

Alternatively, the device for modifying the BPP includes at least one optical element configured to operate in reflection, at an angle of incidence α of between 5 and 50° (FIG. 4). In reflection, at least one face of the optical component 16 is coated with a reflective coating. The materials used to produce the optical device 16 may be fused silica, quartz, special glass, materials of the ZnS or ZnSe type, or metallic materials, for example copper.

In addition, the device for modifying the BPP of the focused beam 10a may employ other optical functions of the type for focusing, correcting or homogenizing the beam. Preferably, the optical device of the invention combines a focusing function with a function of modifying the BPP of the focused laser beam.

The thickness of the component 16 is typically between 0.5 and 10 mm, preferably between 3 and 7 mm. These thickness values are preferable if the device is required to withstand high pressures or temperatures, that is to say pressures that may be up to 25 bar and temperatures of more than 100° C. Typically, the component 16 is circular and its diameter is between about 25 and 75 mm and preferably equal to that of the collimating and focusing optical elements of the cutting head 3.

The following description will allow the nature of the optical device on which the invention rests to be better understood.

The optical device 16 used to modify the BPP of the laser beam is formed from an optical phase component, or more preferably a diffracting optical element. The component serves for spatially modulating the phase on the wavefront of the incident beam 10. By using a suitable phase modulation feature, the wavefront of the incident beam 10 may be altered, adjusted or modified so as to obtain a focused beam 10b having the desired BPP value, different from the BPP value of the incident beam 10.

The optical device 16 is incorporated into the laser cutting head (3, 4) and placed in the optical path of the laser beam 10, as illustrated in FIG. 9. Preferably, the optical device 16 suitable for and designed to modify the BPP of the laser beam is positioned before the focusing optic or optics 14 in the path of the collimated laser beam 10.

Depending on the embodiment of the invention, a diffracting optical element 16 is used to modify the BPP of the focused beam 10a, as illustrated in FIG. 1. The surface of the diffractive optic 16 has microstructures etched in the substrate of the component 16 to variable depths of the order of the working wavelength. These microrelieves form a 2D phase map causing locally variable diffraction and phase-shifting of the incident wave. Typically, the diffractive optical element 16 has etching depths at two or more levels. The phase modulation map of the optical element 16 thus consists of two or more phase-shift values. The phase distribution of the element 16 employed is designed to modify the BPP of the laser beam so as to obtain a focused beam 10b, the BPP of which is different from that of the focused beam 10a obtained in the absence of the diffracting optical element 16.

Examples of spatial phase modulation maps that can he implemented on beam-shaping optical components 16 and examples of techniques used to manufacture such components are given in the following documents, to which the reader may refer for other details on this subject:
“Diffractive Optics: Design, Fabrication and Test”; D. C. O'Shea et al., SPIE Press, Bellingham, Wash. (2003);
“Creation of Diffractive Optical Elements by One Step E-beam Lithography for Optoelectronics and X-ray Lithography”, A. A. Aristov et al., Baltic Electronics Conference, Oct. 7-11, 1996, p. 483-486. Tallinn, Estonia; and
“Development of Diffractive Beam Homogenizer”, T. Hirai et al. SEI Technical Review, No. 60, June 2005. p. 17-23.

In addition, the diffractive optics 16 may perform the same optical functions as conventional refractive components. Consequently, an optical device 16 combining a diffractive function 16 with another function, such as a focusing device 14, for focusing the laser beam 10, may also be incorporated into the cutting head 3.

To test the efficiency of the use of an optical element 16 according to the invention, trials were carried out using a unit according to FIG. 3 to adjust/modify the BPP of a laser beam 10 of 2 kW power generated by a Yb-doped fiber laser generator 1 and a conveying fiber 2.

FIGS. 5a and 5b show schematically the configurations tested, without an optical element 16 and with an optical element 16 respectively, and also with the effect that the incorporation of such an element may have on the main parameters of the focused beam.

The BPP of the laser beam was modified using a diffracting optical element 16, as illustrated in FIG. 5b. The element 16 was mounted in a cutting head 3 in the optical path of the collimated beam 10 upstream of the focusing system 14.

For comparison, the same unit was used but without the incorporation of the diffracting optical element 16 downstream of the collimating element 13, as illustrated in FIG. 5a.

The optical element 16 used was a diffracting element made of fused silica. With this optical element 16, the effect obtained is an increase in the waist radius of the focused laser beam and an increase in its divergence, as illustrated by the dashed line ( - - - ) of FIG. 5b showing schematically the modified laser beam 10b compared with the focused laser beam 10a obtained in which the BPP is not modified. The beam 10b has a waist radius ω_{b} and a divergence θ_{b} that differ from those of the focused beam 10a in the absence of an optical element 16.

Focused beam caustics measured using a beam analyzer confirmed the increase in the BPP of the focused beam after introducing the optical element 16 into the path of the collimated laser beam 10 in comparison with the case in which such an optical element 16 is absent.

FIG. 6 shows the results of the experimental measurements of the variation in the radius of the focused beam along the optical propagation axis, before and after insertion of the diffracting optical element 16.

These caustic plots were obtained by measuring the radius of the beam for which 86% of the laser power is contained within a disk of this radius, in successive propagation planes lying within ranges 10 mm on either side of the waist of the focused beam.

An increase in the BPP, resulting from an increase in the waist radius of the focused beam and an increase in its divergence, was found after introducing the optical element 16. In the unit tested, the BPP of the initial focused beam 10a was 3 mm.mrad without the optical element 16 (continuous line in FIG. 6), whereas the BPP of the modified focused beam 10b with the optical element 16 was 8.6 mm.mrad (clotted line in FIG. 6).

This thus demonstrates that by incorporating a diffractive optics into a laser beam focusing device, such as a cutting head, it is possible to bring the BPP of the focused beam to values that cannot be obtained simply by using conventional optical devices, such as lenses, mirrors, because these elements are not capable of significantly modifying the BPP of a laser beam.

In all cases, by integrating an optical device 16 capable of modifying the BPP of the incident laser beam into a laser cutting head (3, 4), the BPP of the focused beam 10a may be adjusted according to the range of thicknesses cut so as to optimize the performance of the process in terms of cutting speed and quality.

In the end, the initial BPP of the focused laser beam is increased by a factor of between 1.2 and 5, it also being possible to modify the initial intensity profile of the beam, namely a quasi-Gaussian, ring or other profile.

To demonstrate the benefit of the process of the invention, cutting trials were carried out on mild steel and on stainless steel using a fiber laser emitting radiation of 1.07 μm wavelength with a power of 2 kW, using beams having different BPP values. More precisely, the performances obtained in terms of cutting speed and quality with focused beams having two different BPP values, namely 2.4 mm.mrad and 4.3 mm.mrad, were compared.

The cutting head used consisted of a collimator with a focal length of 55 mm, combined with focusing lenses of focal length equal to 127 mm and 190.5 mm, depending on the material cut.

For each material, the performances obtained with the two different BPP values and identical optical combinations were compared.

In the case of mild steel, the trials were carried out on thicknesses ranging from 2 to 10 mm for oxygen pressures ranging from 0.5 to 1.6 bar, whereas in the case of stainless steel, the trials were carried out on thicknesses ranging from 1.5 to 8 mm for nitrogen pressures ranging from 15 to 19 bar.

In all cases, the assistance gas was delivered by nozzles having diameters between 1 and 3 mm.

FIG. 7 shows the cutting speeds achieved as a function of the thickness of the mild steel to be treated and the BPP of the focused beam used during the cutting.

The solid curve ( - - - ) joins the points obtained for a focused beam having a BPP of 2.4 mm.mrad, whereas the dotted curve ( - - - ) joins the points obtained for a focused beam having a BPP of 4.3 mm.mrad.

The filled symbols correspond to good cutting quality (absence of burrs, acceptable roughness), whereas the opened symbols signify that burrs are present and that the quality is not of an industrially acceptable level.

The results obtained a mild steel show that the focused beam of the lower BPP allows smaller thicknesses (2 mm) to be cut more quickly, whereas the focused beam of higher BPP improves the cutting quality for thicknesses of 8 and 10 mm.

The industrial benefit of being able simply to modify the BPP of a focused laser beam, in accordance with the invention using for example an adapted phase component, making it possible here to go from a BPP of 2.4 mm.mrad to a BPP of 4.3 mm.mrad, taking into account the characteristics and specificities of a material to be cut, in particular its composition and thickness, is therefore immediately understood.

According to the same principle, FIG. 8 shows the results obtained on stainless steel. As may be seen, plates of 2 mm were cut at higher speed with the focused beam having a BPP of 2.4 mm.mrad, while the cutting quality is improved on 4 min thick plates with the focused beam having a BPP of 4.3 mm.mrad. The BPP values were obtained as in the previous trials.

These results confirm the benefit of the process and the device of the invention since they demonstrate that a judicious choice of the BPP of the focused laser beam, in particular according to the thickness of the treated material, allows the performances of the laser cutting process to be optimized in terms of cutting speed and quality.

The choice of most appropriate BPP for cutting a plate of given characteristics, especially in terms of metallurgic composition or grade and/or thickness, and/or of the phase or similar component to be used to obtain said desired BPP may be made empirically by cutting trails on specimens of the plate to be cut with a focused laser beam having different BPP values or with different phase components resulting in different multiplicative factors, and by comparing the results thus obtained.

The process of the invention therefore is based on the use of an ytterbium-doped fiber laser and the use of at least one optical element for changing the quality or BPP of the focused laser beam, i.e. cutting beam, in order to take into account in particular the characteristics of the material to be cut, thus modifying the propagation characteristics and the energy distribution of the focused laser beam along the kerf.

1-15. (canceled)

16. A process for cutting a workpiece using a laser beam, in which:
a) an incident laser beam, having a given initial beam quality (BPP), is generated by a laser source coupled to at least one optical fiber configured to convey the beam;
b) said incident laser beam is brought to a focusing head having at least one focusing optic;
c) the incident laser beam is focused by the focusing optic so as to obtain a focused laser beam; and
d) the workpiece is cut by the focused laser beam,
characterized in that the BPP of the incident laser beam is adjusted or modified by an optical device suitable for and configured to modify or act on the BPP of a laser beam so as to obtain a focused laser beam having a modified BPP that differs from the BPP of said incident laser beam, said optical device comprising at least one diffracting optical component and capable of producing a modified focused laser beam, the BPP of which is different from the initial BPP of the incident laser beam by a multiplicative factor equal to or greater than 1.2 but less than or equal to 5.

17. The process of claim 16, wherein the optical device capable of modifying the BPP of the laser beam is placed in the path of the incident laser beam.

18. The process of claim 16, wherein the BPP of the incident beam is between 0.33 and 25 mm.mrad, preferably less than or equal to 10 mm.mrad in the case of a conveying optical fiber with a diameter of 200 μm or less.

19. The process of claim 16, wherein the optical device is capable of producing a modified focused laser beam, the BPP of which is different from the initial BPP of the incident laser beam by a multiplicative factor equal to or greater than 1.5 and/or less than or equal to 3.

20. The process of claim 16, wherein the optical device produces a change in the value of the BPP of the initial focused beam by modifying the waist radius (ωₐ) and the divergence (θₐ) of the focused laser beam.

21. The process of claim 16, wherein the optical device is at least one transmissive or reflective diffracting optical element.

22. The process of claim 16, wherein the focusing head comprises at least one focusing optic and the optical device is suitable for and adapted to modify or act on the initial BPP of the incident laser beam.

23. The process of claim 16, wherein the optical device comprises a fused silica, quartz, special glass, ZnS, ZnSe or a metallic material.

24. The process of claim 16, wherein the optical device has a thickness of between 0.5 and 10 mm and is circular with a diameter of between 25 and 75 mm.

25. The process of claim 16, wherein the optical device is of reflective type, operating with an angle of incidence (α) of between 5 and 50°.

26. The process of claim 16, wherein the wavelength of the laser beam is between 1.06 and 1.10 μm.

27. The process of claim 16, wherein the power of the laser beam is between 0.1 and 25 kW.

28. The process of claim 16, wherein a laser beam is generated by a ytterbium-doped fiber laser source.

29. A laser cutting unit comprising a laser source operably connected to a beam-conveying fiber and a focusing head wherein the beam-conveying fiber is adapted to generate a laser beam having a given initial BPP and a laser beam path, the laser beam directed at the focusing head, which comprises a focusing optic, wherein the laser cutting unit is further characterized in that at least one optical device suitable for and configured to modify or adjust the initial BPP of an incident laser beam is placed in the path of the laser beam path, said optical device comprising at least one diffracting optical component and being suitable for and configured to produce a modified focused laser beam, the BPP of which is different from the initial BPP of the incident laser beam by a multiplicative factor equal to or greater than 1.2 but less than or equal to 5.

30. The unit of claim 29, wherein the optical device is between the beam-conveying fiber and the focusing optic and/or the laser source is an ytterbium-doped fiber laser source.
